(19) United States
(12) Patent Application Publication
(10) Pub. No.: US 2008/0074432 A1
(43) Pub. Date: Mar. 27, 2008

(54) METHOD FOR ACQUIRING A COMPUTER SCREEN IMAGE

(76) Inventors: Chengkun Sun, Beijing (CN); Hongwei Li, Beijing (CN); Yiqiang Yan, Beijing (CN); Xiaohua Jiang, Beijing (CN); Shaoping Peng, Beijing (CN)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/862,614

(22) Filed: Sep. 27, 2007

(30) Foreign Application Priority Data
Sep. 27, 2006 (CN) 200610113404.7

(51) Int. Cl. G06F 13/14

(52) U.S. Cl. 345/520

(57) ABSTRACT

A method for acquiring a computer screen image is disclosed that includes the steps of: acquiring the update region of a non-hardware-accelerated image and adding the acquired update region to an update-region list; acquiring a hardware-accelerated image by intercepting the invocation of a graphics/image hardware-acceleration interface; and combining update regions in the update-region list and acquiring the image data of the combined update region from a frame buffer. With the method of the present invention, both hardware-accelerated and non-hardware-accelerated images on the computer screen can be acquired rapidly at the same time.

### RELATED APPLICATION

The present application claims priority to Chinese Application No. 200610113404.7. filed Sep. 27, 2006, which is incorporated herein in its entirety by reference.

### BACKGROUND OF THE INVENTION

1. Field of the Invention

The present invention relates to the field of computer graphics and image display, and in particular to a method for acquiring a screen image of a personal computer (PC) in a complete and quick manner.

2. Description of the Prior Art

With the increasing enhancement of computation as well as graphics and image processing performance of PCs, computer graphics and images have evolved from early 2D bitmaps and vectors to 3D and video, and even more intricate images in some cases. This imposes a huge challenge on various applications, such as obtaining all content (including images requiring hardware acceleration, e.g., video and 3D) displayed by a PC, and synchronously displaying them on a remote terminal (e.g., remote control, wireless projection, desktop sharing and the like) or any other display device (e.g., wireless display device), especially on those having strict requirements for real-time processing.

The existing methods for capturing a screen primarily include the methods as follows.

(1) The first method consists of inputting to a video capturing card the VGA output signal from a PC display adapter as the input source, and processing the inputted data by the video capturing card. Such a scheme needs the additional hardware of a video card and hardware renovation for the computer, thereby complicating the device configuration. Further, such a scheme is difficult to universalize.

(2) The second method comprises disabling the hardware-acceleration function of the PC display adapter so as to draw (render) the whole displayed image into the computer's FrameBuffer; and then copying bitmap data in FrameBuffer by use of such technology as “periodic screen copy”, “update region screen copy”, “drawing primitive copy” and “screen mirroring”. In this scheme, images, such as 3D/video, requiring hardware acceleration cannot be displayed in a normal way (or display quality is poor) at the time of acquiring a screen image, since the hardware-acceleration function of the current display device is disabled. For instance, if a screen on which a webpage with embedded video is to be captured, this method cannot acquire the image of the video window due to the disability of the hardware-acceleration function.

(3) The third method includes using HOOK to intercept the invocation of the graphics/image hardware-acceleration interface (e.g., DirectX/OpenGL), and acquiring in a real time manner the image that has been hardware-accelerated by the display adapter. With this scheme, only image data (e.g., 3D/video image) that has been hardware-accelerated by the display adapter can be acquired. With respect to the example mentioned in (2), the method can acquire only the embedded video image rather than all the images displayed on the screen.

Therefore, it is desirable to develop a method for acquiring both hardware-accelerated and non-hardware-accelerated images in a synchronized and quick way.

### SUMMARY OF THE INVENTION

The present invention is accomplished in view of the above problems. It is an object of the invention to provide a method for acquiring a PC screen image in a complete and rapid way, which can acquire quickly hardware-accelerated and non-hardware-accelerated images at the same time.

In one embodiment of the present invention, a method for acquiring a computer screen image is provided, comprising the steps of: acquiring the update region of a non-hardware-accelerated image and adding the acquired update region to an update-region list; acquiring a hardware-accelerated image by intercepting the invocation of a graphics/image hardware-acceleration interface; and combining update regions in the update-region list and acquiring the image data of the combined update region from a frame buffer.

Further, according to another embodiment of the present invention, the method comprises steps of: acquiring the display information of the hardware-accelerated image; creating a corresponding update region in the frame buffer based on the display information; and adding the created update region to the update-region list.

Further, according to yet another embodiment of the present invention, the display information includes at least one of size, position and display mode.

Further, according to another embodiment of the present invention, the step of creating a corresponding update region in the frame buffer comprises filling a corresponding region in the frame buffer with KeyColor to create an update region of corresponding size.

Further, according to yet another embodiment of the present invention, the method comprises the steps of: creating an update region corresponding to the hardware-accelerated image rendered in the frame buffer, and adding the created update region to the update-region list.

Further, according to another embodiment of the present invention, said graphics/image hardware-acceleration interface includes DirectX and/or OpenGL.

With the above inventive solutions, it is possible to obtain on-screen-display images accurately without the addition of any hardware device. On the other hand, both hardware-accelerated and non-hardware-accelerated images on the computer screen can be simultaneously acquired, that is, the whole computer screen image can be acquired without any loss in its intactness. Furthermore, according to the present invention, all updates of the computer screen (including hardware-accelerated and non-hardware-accelerated images) can be precisely acquired with a smaller amount of data and higher speed.

### BRIEF DESCRIPTION OF THE DRAWINGS

The above advantages and features of the present invention will be more apparent from the following detailed description taken in conjunction with the drawings in which:

FIG. 1 is a diagram for explaining the relationship between software modules employed in a method of acquiring a computer screen image according to one embodiment of the present invention; and

FIG. 2 is a flowchart for explaining the method of acquiring a computer screen image according to one embodiment of the present invention.

### DETAILED DESCRIPTION OF THE PREFERRED EMBODIMENTS

Now, one embodiment of the present invention will be elaborated with reference to the figures, throughout which the same reference symbols, though shown in different figures, represent the same or similar components. For the purpose of clarity and conciseness, the detailed description of known functions and structures incorporated here will be omitted. Otherwise, they may obscure the subject of the present invention.

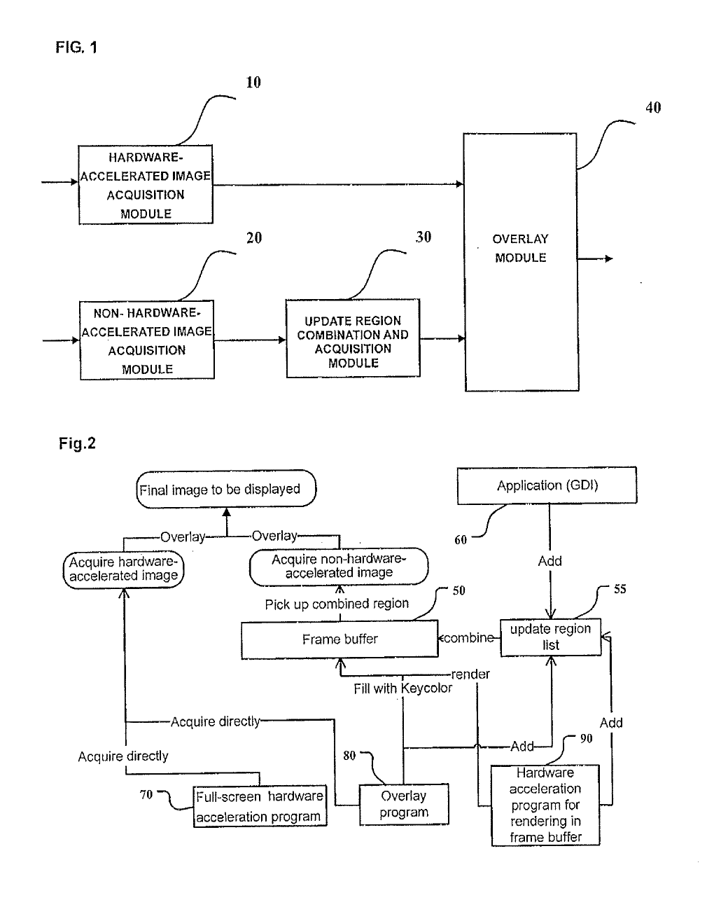

FIG. 1 is a diagram for explaining the relationship between software modules employed in a method of acquiring a computer screen image according to one embodiment of the present invention.

As shown in FIG. 1, the software modules used in the inventive method include: a hardware-accelerated image-acquisition module 10 for intercepting every invocation of a graphics/image hardware-acceleration interface (e.g., DirectX/OpenGL) so as to acquire the data of a hardware-accelerated image; a non-hardware-accelerated image-acquisition module 20 for acquiring the update of a non-hardware accelerated image by means of a screen-mirroring technique for the update region, and adding the acquired update to an update-region list; update-region combination-and-acquisition module 30 for combining update regions in the update-region list, and picking up the image data of the combined-screen region from a frame buffer (FrameBuffer); and an overlay module 40 for overlaying the data of the hardware-accelerated image acquired by the hardware-accelerated image-acquisition module 10 on the image data acquired by the update-region combination-and-acquisition module 30 for display in a screen.

FIG. 2 is a flowchart for explaining the method of acquiring a computer screen image according to one embodiment of the present invention.

As shown in FIG. 2, the method of the present invention starts with loading the non-hardware-accelerated image-acquisition module 20 and the hardware-accelerated image-acquisition module 10.

If the currently-displayed image is a full-screen hardware-accelerated image, the data of the hardware-accelerated image is acquired in a realtime manner from a full-screen hardware-acceleration program 70 by intercepting the invocation of the graphics/image hardware-acceleration interface by the hardware-accelerated image-acquisition module 10.

If the currently-displayed image is a non-hardware-accelerated image, using the screen-mirroring technique for the update region, the non-hardware-accelerated image-acquisition module 20 acquires all updates of the non-hardware-accelerated image to be added to the update-region list by the application (GDI) 60. The updates are added into the specified update-region list 55, and only coordinates of the update regions are disposed in the update-region list 55.

If the currently-displayed image is a hardware-accelerated image rendered in the frame buffer 50 by the hardware-acceleration program for rendering in the frame buffer 90, the non-hardware-accelerated image-acquisition module 20 creates an update region having the same size as the hardware-accelerated image rendered in the frame buffer and adds the update region to the update-region list 55.

If the currently-displayed image is a hardware-accelerated image with Overlay, the non-hardware-accelerated image-acquisition module 20 utilizes the Overlay program 80, i.e., Overlay update-invoking interface, to acquire the current information about Overlay on the screen, such as display location, window size and display mode, then fills a corresponding region in the frame buffer 50 with KeyColor (some color value to which the human eye is insensitive, for example, a color close to black, and that the Overlay image color to be displayed can penetrate) and creates an update region of corresponding size to be added to the update-region list 55. Meanwhile, the hardware-accelerated image-acquisition module 10 acquires the data of the hardware-accelerated image in a real time fashion through the hardware-acceleration-invoking interface.

Next, the update-region combination-and-acquisition module 30 combines the update regions in the update-region list and picks up the data of the combined-screen region from the frame buffer so as to obtain all the data of the non-hardware-accelerated image.

Finally, the overlay module 40 overlays the obtained hardware-accelerated and non-hardware-accelerated images together for display on the screen.

Now, a detailed explanation will be given to the process of one embodiment of an inventive method for acquiring a screen image in Overlay mode.

For the scenario in which hardware-accelerated and non-hardware-accelerated images are displayed simultaneously on the computer screen, for example, a video window of size (480*320) is embedded at the upper left corner (0,0) of an Internet webpage of size (1024*768), the video window is displayed in Overlay mode.

First, the non-hardware-accelerated image-acquisition module 20 is loaded to acquire all updates in the webpage, with the updates being one or more rectangular regions, and to add the updates (one or more rectangular regions) to the update-region list 55. As mentioned previously, only the locations and sizes of the one or more updated rectangular regions are shown in the update-region list 55.

Then, the hardware-accelerated image-acquisition module 10 is loaded to intercept the invocation of the graphics/image hardware-acceleration interface by the video window, duplicate the data of the video image, acquire the display location of the Overlay image layer for the video window (in one embodiment, the coordinates of the rectangular region may be (0,0,480,320)) with the KeyColor capable of being displayed transparently, such as RGB (16,0,16), and to fill the corresponding region defined by, for example, (0,0,480,320) in the webpage with the color of KeyColor. In one embodiment, a rectangle of size defined by (0,0,480,320) is created upon the completion of the filling and added to the update-region list 55.

Next, the update-region combination and acquisition module 30 combines the update regions in the update-region list and picks up the combined webpage region from the frame buffer 50.

In the end, the overlay module 40 overlays directly the data of both the duplicated video image and the picked-up webpage image to obtain the final result, namely the webpage with the video window displayed at the upper left corner.

Although the above description is intended to implement several embodiments of the present invention, those skilled in the art will appreciate that any modification and partial substitution within the scope of the invention should belong to the scope of the present invention as defined in the appended claims. Therefore, the scope of the present invention should be defined by the claims.

1. A method for acquiring a computer screen image, comprising the steps of:
acquiring an update region of a non-hardware-accelerated image and adding the acquired update region to an update-region list;
acquiring a hardware-accelerated image by intercepting the invocation of a graphics/image hardware-acceleration interface; and
combining update regions in the update-region list and acquiring image data of the combined update region from a frame buffer.

2. The method according to claim 1, further comprising the steps of:
acquiring display information of the hardware-accelerated image;
creating a corresponding update region in the frame buffer based on said display information; and
adding the created update region to the update-region list.

3. The method according to claim 2, wherein said display information includes size, position, display mode, or a combination of the foregoing.

4. The method according to claim 2, wherein said step of creating a corresponding update region in the frame buffer comprises filling a corresponding region in the frame buffer with KeyColor to create an update region of corresponding size.

5. The method according to claim 1, further comprising the steps of:
creating an update region corresponding to the hardware-accelerated image rendered in the frame buffer; and
adding the created update region to the update-region list.

6. The method according to claim 1, wherein said graphics/image hardware-acceleration interface includes DirectX, OpenGL, or both of the foregoing.
